(19) United States
(12) Patent Application Publication
(10) Pub. No.: US 2019/0133115 A1
(43) Pub. Date: May 9, 2019

(54) PESTICIDAL SOLUBLE MICRO-EMULSION CONCENTRATE SEED TREATMENT FORMULATIONS

(71) Applicants: John M. Moyer IV, Walnutport, PA (US); Justin Seckel, Platte City, MO (US); Stefanie Clifford, Saint Joseph, MO (US)

(72) Inventors: John M. Moyer IV, Walnutport, PA (US); Justin Seckel, Platte City, MO (US); Stefanie Clifford, Saint Joseph, MO (US)

(21) Appl. No.: 15/807,298

(22) Filed: Nov. 8, 2017

(51) Int. Cl. A01N 25/04; A01N 25/30; A01N 37/46

(52) U.S. Cl. CPC A01N 25/04; A01N 2300/00; A01N 37/46; A01N 25/30

(57) ABSTRACT

The present invention comprises a seed treatment applied to and bound to the seed in such a way as to reasonably maintain its activity, usually over a period of time and over a given space around the seed. To accomplish these objectives, the seed treatment has been prepared and constructed in such a way as to be released in a generally predictable manner. Previous seed treatment formulations have not employed micro-emulsion platforms to safely deliver active ingredients to the seed surface whereas the present invention provides means to use a micro-emulsion platform to obtain the objectives of the seed treatment.

### FIELD OF THE INVENTION

The development and use of pesticide micro-emulsions have been well known for their utility in the traditional Agricultural and Turf & Ornamental markets. The present invention generally concerns seed treatment applications comprising micro-emulsion in concentrate or ready-to-use formulations and seeds pretreated thereby for the purpose of resisting pests and insects. Various means have been employed to bind an active ingredient to the seed in such a way that allows even and predictable loading onto the seed. However, there is room for improvement in the art, specifically, a seed treatment, that comprises means to provide more predictability for release in various conditions was still needed.

### BACKGROUND OF THE INVENTION

The practice of treating seed with pesticide formulations is well known. Fungicides and Insecticides are applied to crop seeds separately or in combination to protect them from pests in the soil and throughout the early growing stages. Four types of formulations are widely used;
1. aqueous flowables (suspension concentrates) which typically include aqueous concentrated compositions of solid particulate water insoluble substances which flow as viscous liquids;
2. wettable powders, which, when mixed with water do not dissolve but, instead, form a suspension; and
3. granular form which may include water dispersible granules or extruded granules; and
4. water dispersible granules which are like wettable powders except instead of being dust-like, they are formulated as small, easily measured granules which are mixed with water to be applied or may be applied dry with water applied secondly. Once in water, water dispersible granules break apart into fine particles similar to wettable powders. If mixed with water, a water-dispersible granular formulation typically requires constant agitation to keep the granules suspended in water. The percentage of active ingredient can be high, sometimes as much as 90 percent by weight. Water-dispersible granules share many of the same advantages and disadvantages of wettable powders except they are more easily measured and mixed, and pose less inhalation hazard to the applicator during handling.

In common circumstances, pesticide formulations for seed treatments are mixed together with one another in addition to binding agents, flow agents, and colorants. Binding agents are used to cause the formulation to bind together upon drying on a surface to which the formulation is applied, similar to paint. Whereas, flow agents are additives included in powdered or granulated material to prevent the formation of lumps (caking). Water-soluble polymer coatings, water-insoluble but water-sensitive seed coatings that disintegrate when contacted with water, and non-phytotoxic polymer-based film coatings which may or may not also include lubrication are known. Seed treatments may even include plant seed-binding protein. These types of formulations may be commonly known as “Custom Blends.” Under 40 CFR Subchapter E Part 167 Subpart A 167.3, Custom Blends are referred to as a mixture containing pesticides made to a customer's specifications. A Custom Blend usually comprises a pesticide (s)—fertilizer (s) mixture, a pesticide—pesticide mixture, or a pesticide—animal feed mixture.” When blending and producing Custom Blends, several issues arise from highly loaded active ingredient concentrations of several suspension concentrate, wettable powder, and granular formulations. These highly loaded concentrations result in high percent weight by weight solids which, in turn, may cause incremental increase in viscosity and decreased stability. Both commercial seed treatment formulations and Custom Blends of increased viscosity require the use of specialized and mechanically diversified equipment in order to move, package, and evenly apply the seed treatments. Appropriate handling and pumping of formulations, Custom Blends and slurries becomes critical to ensure uniform seed coverage.

There are a variety of compositions that may be applied as seed treatment. Some of these comprise one or more active ingredients. For example, U.S. Pat. No. 5,661,103 discloses a seed treatment that is a water soluble non-aromatic polyamino acid of molecular weight of more than 1500. U.S. Pat. No. 6,455,468 covers a composition of choline chloride, calcium-containing salt, potassium containing salt and salicylic acid as a seed treatment. US Pat. App. 20030224936 covers an aqueous film forming seed treatment composition where the film is a crosslinked proteinaceous material combined with an active such as a pesticide, fertilizer, or bioregulating additives. Another seed treatment was disclosed by US Application 20150299057 as a composition of waterborne resin (e.g. acrylic, polyurethanes, urethane acrylics) and a water-dispersible plant protein such as deamidated gluten.

The effectiveness of seed treatments such as those mentioned herein may be influenced by a number of different conditions or materials. For example, soil temperature, pH, moisture levels, and high levels of exudates released during germination.

Metalaxyl is a systemic fungicide, C15H21NO4, (See FIG. 1 for its molecular structure) used for controlling, e.g., systemic downy mildew, Pythium seed rot, Pythium damping-off, early season phytophthora diseases, and others by disrupting the fungal nucleic acid synthesis, specifically inhibiting RNA. It has been registered for use on over 100 crops including more than 30 seed treatment uses. Application ranges from 0.135 to 8 lb/acre depending on crop and soil conditions to 0.25-1.12 oz per 100 lbs of seed. It can be applied in any of several forms including broadcast, drenching, sprinkling, band spraying, granular, pelleted, spikes and wettable powder. Metalaxyl is an acylalanine fungicide, specifically, methyl N-(methoxyacetyl)-N-(2,6-xylyl)-DL-alanate and is soluble in alcohols, e.g., ethanol, acetone, and toluene) and is produced by reaction of 2,6 dimethylanaline with an excess of methyl 2-bromopropionate in the presence of sodium bicarbonate, followed by acetylation with methoxyacetyl chloride. It may be provided as emulsifiable concentrate, granules, flowable and wettable powders. It has a half-life of 40 days which can be much faster in soils with higher levels of organic content.

Despite prior art, there remains the need for a seed treatment for pesticide formulations that have a more stable and soluble platform for some active ingredients to enhance long term storage stability that are compatible with custom blend applications, are biologically safe on seed, and that exhibits adequate seed protection. Such a novel seed treatment would represent an improvement over previous products, methods and results.

### SUMMARY OF THE INVENTION

The applicants discovered a novel composition that includes a combination of pesticidal active ingredient or ingredients that are solubilized in a solvent or solvents and form a micro-emulsion when specific surfactants are added to said composition. These seed treatment pesticide formulations have a more stable and soluble platform for some active ingredients, enhance long term storage stability, are compatible with custom blend applications, and, surprisingly, are biologically safe for seed, and exhibit adequate seed protection.

Specifically, the present invention comprises aqueous and non-aqueous pesticidal seed treatment formulations that include from about 0.1 to about 35% w/w of at least one or more pesticide active ingredients, about 2-98% tetrahydrofurfuryl alcohol, or one or a combination of other suitable solvents, about 0.1 to 98% water, an antifoam at 0.01-1.00% w/w and a surfactant. The surfactant's concentration is dependent upon the w/w % of pesticidal active ingredient in the formulation.

In another embodiment, the present invention is a soluble seed treatment pesticide formulation containing 0.1-45% w/w Metalaxyl, from about 2-98% tetrahydrofurfuryl alcohol, about 0.1 to 98% water, an antifoam at 0.01-1.00% and 1-98% ethoxylated non-ionic surfactant.

In another embodiment, the present invention is a soluble seed treatment pesticide formulation containing 0.1-45% w/w Azoxystrobin, from about 2-98% tetrahydrofurfuryl alcohol, about 0.1 to 98% water, an antifoam at 0.01-1.00% and 1-98% ethoxylated non-ionic surfactant.

In another embodiment, the present invention is a soluble seed treatment pesticide formulation containing 0.1-45% w/w Tebuconazole, from about 2-98% tetrahydrofurfuryl alcohol, about 0.1 to 98% water, an antifoam at 0.01-1.00% and 1-98% ethoxylated non-ionic surfactant.

In another embodiment, the present invention is a soluble seed treatment pesticide formulation containing 0.1-45% w/w Fludioxonil, from about 2-98% tetrahydrofurfuryl alcohol, about 0.1 to 98% water, an antifoam at 0.01-1.00% and 1-98% ethoxylated non-ionic surfactant.

A further aspect of the present invention includes application directly to seeds. Application of the inventive seed treatment may be directly to seeds or diluted and applied biologically safely to seeds. Traditional agricultural solvents are phytotoxic to seeds if used in seed treatments, however, the seed treatment formulations of the present invention do not exhibit phytotoxicity.

An additional aspect of the present invention is that the seed treatment of the present invention can be incorporated into custom blend products that can be applied biologically safely either directly to seeds or first diluted and then applied to seeds. A biologically safe custom blend product of the present invention will not statistically increase the number of seeds that do not germinate or are otherwise not viable over the rate expected when using traditional seed treatments.

### BRIEF DESCRIPTION OF THE DRAWINGS

FIG. 1 is the molecular structure of C15H21NO4

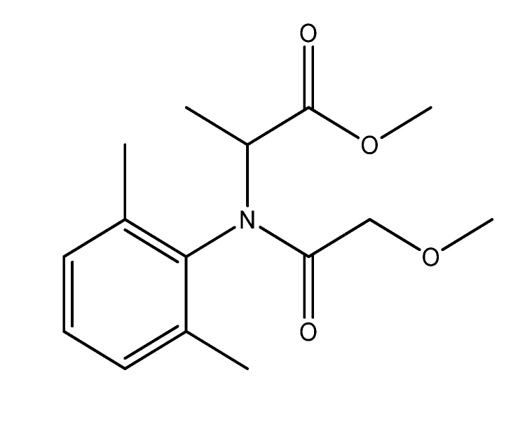

### DETAILED DESCRIPTION OF THE INVENTION

The present invention relates to pesticidal soluble micro-emulsion concentrate formulations containing at least one pesticidal agent, specifically a fungicide or insecticide, a water miscible solvent and an ethoxylated non-ionic surfactant. Further, alkyl diols or alkyl triols may optionally be added as a co-solvent/antifreeze. Prior attempts implied that seed may be harmed by application of the formulation.

Applicants discovered that the use of a water miscible solvent such as Tetrahydrofurfuryl Alcohol as a solvent for pesticidal soluble micro-emulsion concentrate formulations unexpectedly results in a safe and stable formulation. Further, unlike formulations using aqueous solvents, these soluble micro-emulsion concentrate formulations showed no crystals after being stored at −6 C for 6 weeks, 45 C for 6 weeks and after freeze-thaw cycles. This innovation addresses the prior art problem of crystallization.

In one embodiment the at least one pesticide is the fungicide Metalaxyl. Other embodiments include additional standalone fungicides or combinations thereof such as Azoxystrobin, Tebuconazole, Fludioxonil, and Toclofos-methyl.

Examples of other Insecticides and/or Fungicides that may be included are, but are not limited to, the following:

Neonicotinoid Insecticides—Such as Imidacloprid, Acetamiprid, Clothianidin, Dinotefuran, Nithiazine, Thiacloprid and Thiamethoxam.

Organophosphorus Fungicides—Such as Ampropylfos, Ditalimos, Edifenphos, Fosetyl, Inezin, Iprobenfos, Izoamfos, Phosdipen, Pyrazopos, Toclofos-Ethyl, and Triamiphos.

Phenylamide Fungicides—Such as Metalaxyl and Metalaxyl-M

Phenylpyrrole Fungicides—Such as Fludioxonil, Dimetachlone, Fenpiclonil, and Fluroimide

Benzimidazole Fungicides—Such as Albendazole, Benomyl, Carbendazim, Chlorfenazole, Cypendazole, Debacarb, Fuberidazole, Mecarbinzid, Rabenzazole, Thiabendazole, Thiophanate, and Thiophanate-methyl.

Triazole Fungicides—Such as Epoxiconazole, Triadimenol, Propiconazole, Metconazole, Cyproconazole, Tebuconazole, Azaconazole, Bromuconazole, Diclobutrazol, Difenoconazole, Diniconazole, Etaconazole, Fenbuconazole, Fluquinconazole, Flutriafol, Furconazole, Hexaconazole, Imibenconazole, Ipconazole, Myclobutanil, Penconazole, Prothioconazole, Quinconazole, Simeconazole, Tetraconazole, Triadimefon, Triticonazole, and Uniconazole.

Organophosphorus Insecticides—Such as Parathion, Acephate, Malathion, Methyl Parathion, Chlorpyrifos, Diazinon, Dichlorvos, Phosmet, Fenitrothion, Tetrachlorvinphos, Azamethiphos, and Azinphos Methyl.

Strobilurin Fungicides—Such as Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, and Trifloxystrobin.

Phthalimide Fungicides—Such as Captafol, Captan, Ditalimfos, Folpet, and Thiochlorofenphim.

Oxathiin Fungicides—Such as Caroboxin and Oxathiin.

Dithiocarbamate Fungicides—Such as amobam, asomate, azithiram, carbamorph, cufraneb, cuprobam, disulfiram, ferbam, metam, nabam, tecoram, thiram, urbacide, and ziram.

Amide Fungicides—Such as boscalid, carboxin, carpropamid, diclomet, ethaboxam, funfuram, fenhexamid, flusulfamide, flutolanil, furametpyr, mepronil, ofurance, oxadixyl, pyracarbolid, thifluzamide, tiadinil, and zoxamide

Aromatic Fungicides—Such as chloroneb and chlorothalonil.

Imidazole Fungicides—Such as cyazofamid, fenamidone and triazoxide.

Aliphatic Nitrogen Fungicides such as cymoxanil.

Morpholine Fungicides such as dimethomorph.

Pyrimidine Fungicides—Such as fenarimolferimzone, mepanipyrim, nuarimol and pyrimthanil.

Pyridine Fungicides—Such as fluazinam and fluopicolide,

Benzimidazole Fungicides—Such as fuberidazole and thiabendazole.

Quinoline Fungicides such as quinoxyfen.

The present invention is not limited to Tetrahydrofurfuryl Alcohol as a solvent but other water-miscible solvents are suitable such as Acetone, Acetonitrile, 1,2-Butanediol, 1,3-Butanediol, 1,4-Butanediol, Diethanolamine, Diethylenetriamine, Dimethyl Solfoxide, Ethanol, Ethylamine, Ethylene Glycol, Furfuryl Alcohol, Glycerol, Methanol, Methyl Diethanolamine, 1-Propanol, 1,3-Propanediol, 1,5-Pentanediol, 2-Proponal, Propylene Glcyol, Tetrahydrofuran, and Triethylene Glycol. The unexpected result is that the efficacy of the fungicide or insecticide or both is unaffected and the inventive formulations do not exhibit, or exhibit far less, crystallization after exposure to cool, cold or freezing temperatures followed by thawing.

In another embodiment, the ethoxylated non-ionic surfactant preferably is a 5-40 mol ethoxylated castor oil such as Ethox CO-36. Other classes of ethoxylated non-ionic surfactant are also suitable such as Block Co-Polymers, Tristyrlphenol Ethoxylates, Ethoxylated Alkyl Phenols, Ethoxylated Fatty Acids, Ethoxylated Fatty Amines and other Ethoxylated Glyceridies.

In a preferred embodiment, the formulation contains the preferred amount of a fungicide relative to the intended application, and about 21.62% Metalaxyl, 51.22% Tetrahydrofurfuryl Alcohol, 23.00% Ethox CO-36, 0.10% Antifoam-10, and 4.06% water.

In other embodiments, the formulation contains the preferred fungicides, about 11.60% Metalaxyl, 1.85% Fludioxonil, 59.92% Tetrahydrofurfuryl Alcohol, 20.00% Ethox CO-36, 0.10% Antifoam-10, and 6.53% water.

Also, in still other embodiments, the formulation contains the preferred fungicides, about 11.41% Metalaxyl, 1.83% Fludioxonil, 7.10% Toclofos-methyl, 52.21% Tetrahydrofurfuryl Alcohol, 23.00% Ethox CO-36, 0.10% Antifoam-10, and 4.35% water.

Most often, the formulation will be employed as about 15% to about 30% of the total combination to be applied. Application rates may range from 0.43-7.37 fluid ounces per cwt (hundred weight) and, preferably 1.05 to 4.2 fluid ounces/cwt.

Another discovery is that these new pesticidal soluble micro-emulsion concentrate formulations are compatible when mixed with other seed treatment suspension concentrate formulations.

In other preferred embodiments, a custom blend would contain 1-11 insecticides or fungicides, a colorant, polymers, bio stimulants, and fertilizers at varying concentrations. The tables below provide example formulations of the present invention and present chemical and physical stability data for each formulation.

### Example A—Formulation

| Component | w/w % |
|---|---|
| Metalaxyl | 21.62 |
| Tetrahydrofurfuryl Alcohol | 51.22 |
| Ethox CO-36 | 23.00 |
| Antifoam-10 | 0.10 |
| Water | 4.06 |

TABLE 1
Chemical Stability of Example A

| | | F/T (−12 C./20 C.) - 8 | 45 C. - 6 |
|---|---|---|---|
| | Time 0 | Cycles | Weeks |
| % a.i. Metalaxyl | 21.99 | 21.95 | 21.55 |

TABLE 2
Physical Stability of Example A

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | Yes, re-dissolved | No |
| pH (1% w/w in DI water) | 6.89 | 6.79 | 6.77 |

### Example B—Formulation

| Component | w/w % |
|---|---|
| Metalaxyl | 21.62 |
| Tetrahydrofurfuryl Alcohol | 46.22 |
| Propylene Glycol | 5.00 |
| Ethox CO-36 | 23.00 |
| Antifoam-10 | 0.10 |
| Water | 4.06 |

TABLE 3
Chemical Stability of Example B

| | | F/T (−12 C./20 C.) - 8 | 45 C. - 6 |
|---|---|---|---|
| | Time 0 | Cycles | Weeks |
| % a.i. Metalaxyl | 21.79 | 22.31 | 22.09 |

TABLE 4
Physical Stability of Example B

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | Yes, re-dissolved | No |
| pH (1% w/w in DI Water) | 6.99 | 7.24 | 6.70 |

### Example C—Formulation

| Component | w/w % |
|---|---|
| Metalaxyl | 11.60 |
| Fludioxonil | 1.85 |
| Tetrahydrofurfuryl Alcohol | 59.92 |
| Ethox CO-36 | 20.00 |
| Antifoam-10 | 0.10 |
| Water | 6.53 |

TABLE 5
Chemical Stability of Example C

| | | F/T (−12 C./20 C.) - | 45 C. - 6 |
|---|---|---|---|
| | Time 0 | 8 Cycles | Weeks |
| % a.i. Metalaxyl | 11.87 | 11.98 | 11.89 |
| % a.i. Fludioxonil | 1.90 | 1.84 | 1.84 |

TABLE 6
Physical Stability of Example C

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 7.02 | 6.97 | 6.59 |

### Example D—Formulation

| Component | w/w % |
|---|---|
| Metalaxyl | 9.60 |
| Azoxystrobin | 1.16 |
| Tetrahydrofurfuryl Alcohol | 43.37 |
| Ethox CO-36 | 22.50 |
| SOPROPHOR TS/10 | 8.50 |
| SOPROPHOR 3D33 | 7.25 |
| RHODOCAL IPAM | 6.50 |
| Antifoam-10 | 0.10 |
| Water | 0.00 |
| | 98.98 |

TABLE 7
Chemical Stability of Example D

| | | F/T (−12 C./20 C.) - | 45 C. - 6 |
|---|---|---|---|
| | Time 0 | 8 Cycles | Weeks |
| % a.i. Metalaxyl | 9.78 | 9.91 | 9.74 |
| % a.i. Azoxystrobin | 1.19 | 1.17 | 1.23 |

TABLE 8
Physical Stability of Example D

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 3.91 | 3.81 | 3.60 |

### Example E—Formulation

| Component | w/w % |
|---|---|
| Metalaxyl | 12.76 |
| Tebuconazole | 0.77 |
| Tetrahydrofurfuryl Alcohol | 57.31 |
| Ethox CO-36 | 25.00 |
| Antifoam-10 | 0.10 |
| Water | 4.06 |
| | 100.00 |

TABLE 9
Chemical Stability of Example E

| | | F/T (−12 C./20 C.) - | 45 C. - 6 |
|---|---|---|---|
| | Time 0 | 8 Cycles | Weeks |
| % a.i. Metalaxyl | 13.09 | 13.01 | 13.02 |
| % a.i. Tebuconazole | 0.78 | 0.80 | 0.79 |

TABLE 10
Physical Stability of Example E

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 6.89 | 6.79 | 5.90 |

### Example F—Formulation

| Component | w/w % |
|---|---|
| Tebuconazole | 16.33 |
| Azoxystrobin | 1.16 |
| Tetrahydrofurfuryl Alcohol | 41.66 |
| Ethox CO-36 | 21.50 |
| SOPROPHOR TS/10 | 7.50 |
| SOPROPHOR 3D33 | 6.25 |
| RHODOCAL IPAM | 5.50 |
| Antifoam-10 | 0.10 |
| | 100.00 |

TABLE 11
Chemical Stability of Example F

| | | F/T (−12 C./20 C.) - | 45 C. - 6 |
|---|---|---|---|
| | Time 0 | 8 Cycles | Weeks |
| % a.i. Azoxystrobin | 1.13 | 1.08 | 1.16 |
| % a.i. Tebuconazole | 15.86 | 15.59 | 15.5 |

TABLE 12
Physical Stability of Example F

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 5.63 | 5.69 | 5.65 |

### Example G—Formulation

| Component | w/w % |
|---|---|
| Tebuconazole | 16.33 |
| Tetrahydrofurfuryl Alcohol | 58.57 |
| Ethox CO-36 | 25.00 |
| Antifoam-10 | 0.10 |
| | 100.00 |

TABLE 13
Chemical Stability of Example G

| | | F/T (−12 C./20 C.) - | 45 C. - 6 |
|---|---|---|---|
| | Time 0 | 8 Cycles | Weeks |
| % a.i. Tebuconazole | 15.47 | 15.67 | 15.52 |

TABLE 14
Physical Stability of Example G

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 5.97 | 5.86 | 5.76 |

### Example H—Formulation

| Component | w/w % |
|---|---|
| Tebuconazole | 16.33 |
| Tetrahydrofurfuryl Alcohol | 29.29 |
| DMSO | 29.29 |
| Ethox CO-36 | 24.99 |
| Antifoam-10 | 0.10 |
| | 100.00 |

TABLE 15
Chemical Stability of Example H

| | | F/T (−12 C./20 C.) - | 45 C. - 6 |
|---|---|---|---|
| | Time 0 | 8 Cycles | Weeks |
| % a.i. Tebuconazole | 15.61 | 15.78 | 15.64 |

TABLE 16
Physical Stability of Example H

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 6.28 | 6.19 | 6.07 |

### Example I—Formulation

| Component | w/w % |
|---|---|
| Fludioxonil | 15.43 |
| Tetrahydrofurfuryl Alcohol | 59.47 |
| Ethox CO-36 | 25.00 |
| Antifoam-10 | 0.10 |
| | 100.00 |

TABLE 17
Chemical Stability of Example I

| | | F/T (−12 C./20 C.) - | 45 C. - 6 |
|---|---|---|---|
| | Time 0 | 8 Cycles | Weeks |
| % a.i. | 15.16 | 15.17 | 15.19 |
| Fludioxonil | | | |

TABLE 18
Physical Stability of Example I

| | | F/T (−12 C./20 C.) - 8 | 45 C. - 6 |
|---|---|---|---|
| | Time 0 | Cycles | Weeks |
| Appearance | Clear | Clear | Clear |
| Crystals | No | No | No |
| pH (1% w/w in DI Water) | 6.62 | 6.34 | 6.28 |

Seed Treatment Application of Formulation Example 1 and Germination Storage Study on Various Crops:

The Formulation Example 1 was applied to various crops at various rates using standard treatment slurries and equipment. Initial germination was assessed and at 7 days, 14 days, and 2 months using both warm and cold methods. Overall all seed safety was surprisingly good. Data is summarized in the following tables.

### Example A Seed Germination

TABLE 19
Example A Seed Germination of Spring Wheat

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 99 | 99 | 98 | 98 | 98 | 97 | 98 | 95 |
| 1.05 oz/100 cwt | 98 | 99 | 98 | 99 | 99 | 94 | 95 | 96 |
| 2.1 oz/100 cwt | 98 | 99 | 97 | 98 | 99 | 92 | 98 | 94 |
| 4.2 oz/100 cwt | 98 | 99 | 98 | 99 | 100 | 91 | 95 | 97 |
| 1:1 w/DI Water | 99 | 99 | 98 | 99 | 98 | 98 | 99 | 96 |

TABLE 20
Example A Seed Germination of Winter Wheat

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 95 | 96 | 95 | 94 | 97 | 96 | 96 | 90 |
| 1.05 oz/100 cwt | 96 | 94 | 94 | 92 | 96 | 96 | 96 | 89 |
| 2.1 oz/100 cwt | 94 | 96 | 95 | 94 | 95 | 95 | 95 | 89 |
| 4.2 oz/100 cwt | 98 | 93 | 94 | 94 | 97 | 96 | 95 | 86 |
| 1:1 w/DI Water | 93 | 96 | 96 | 94 | 97 | 94 | 96 | 90 |

TABLE 21
Example A Seed Germination of Barley

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 80 | 83 | 79 | 51 | 64 | 58 | 68 | 39 |
| 1.05 oz/100 cwt | 76 | 82 | 83 | 48 | 60 | 54 | 64 | 36 |
| 2.1 oz/100 cwt | 79 | 81 | 80 | 39 | 63 | 52 | 64 | 39 |
| 4.2 oz/100 cwt | 68 | 70 | 80 | 40 | 69 | 45 | 55 | 35 |
| 1:1 w/DI Water | 61 | 69 | 81 | 35 | 60 | 50 | 64 | 33 |

TABLE 22
Example A Seed Germination of Triticale

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 91 | 88 | 91 | 91 | 93 | 91 | 92 | 89 |
| 1.05 oz/100 cwt | 91 | 88 | 89 | 89 | 93 | 88 | 96 | 88 |
| 2.1 oz/100 cwt | 92 | 89 | 90 | 90 | 91 | 91 | 90 | 90 |
| 4.2 oz/100 cwt | 91 | 89 | 89 | 89 | 90 | 88 | 97 | 89 |
| 1:1 w/DI Water | 86 | 88 | 88 | 90 | 91 | 86 | 91 | 88 |

TABLE 23
Example A Seed Germination of Oats

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 95 | 99 | 97 | 95 | 99 | 99 | 98 | 95 |
| 1.05 oz/100 cwt | 96 | 99 | 98 | 99 | 98 | 99 | 95 | 98 |
| 2.1 oz/100 cwt | 95 | 99 | 97 | 97 | 100 | 99 | 97 | 95 |
| 4.2 oz/100 cwt | 96 | 100 | 97 | 98 | 99 | 100 | 95 | 95 |
| 1:1 w/DI Water | 97 | 98 | 97 | 97 | 99 | 100 | 94 | 94 |

TABLE 24
Example A Seed Germination of Soybean

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 94 | 93 | 89 | 95 | 88 | 87 | 89 | 91 |
| 1.05 oz/100 cwt | 93 | 94 | 90 | 95 | 89 | 87 | 88 | 89 |
| 2.1 oz/100 cwt | 92 | 96 | 88 | 92 | 84 | 88 | 83 | 91 |
| 4.2 oz/100 cwt | 90 | 94 | 86 | 92 | 85 | 87 | 82 | 85 |
| 1:1 w/DI Water | 90 | 91 | 86 | 94 | 79 | 87 | 79 | 86 |

TABLE 25
Example A Seed Germination of Corn

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 95 | 98 | 93 | 94 | 94 | 92 | 92 | 92 |
| 1.05 oz/100 cwt | 94 | 97 | 93 | 93 | 88 | 91 | 89 | 89 |
| 2.1 oz/100 cwt | 94 | 97 | 94 | 93 | 90 | 88 | 86 | 89 |
| 4.2 oz/100 cwt | 95 | 97 | 94 | 93 | 78 | 84 | 84 | 74 |
| 1:1 w/DI Water | 95 | 92 | 93 | 92 | 70 | 69 | 76 | 74 |

TABLE 26
Example A Seed Germination on Cotton

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 80 | 73 | 65 | 75 | 32 | 22 | 29 | 38 |
| 1.05 oz/100 cwt | 88 | 73 | 65 | 78 | 31 | 29 | 39 | 40 |
| 2.1 oz/100 cwt | 80 | 80 | 67 | 79 | 40 | 28 | 34 | 37 |
| 4.2 oz/100 cwt | 76 | 66 | 64 | 83 | 36 | 26 | 38 | 37 |
| 1:1 w/DI Water | 79 | 76 | 62 | 80 | 34 | 15 | 24 | 36 |

TABLE 27
Example A Seed Germination on Black Beans

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 94 | 90 | 90 | 90 | 85 | 93 | 92 | 90 |
| 1.05 oz/100 cwt | 97 | 92 | 92 | 95 | 84 | 91 | 85 | 91 |
| 2.1 oz/100 cwt | 95 | 89 | 91 | 89 | 83 | 91 | 88 | 90 |
| 4.2 oz/100 cwt | 93 | 90 | 92 | 87 | 84 | 86 | 84 | 85 |
| 1:1 w/DI Water | 98 | 90 | 93 | 93 | 87 | 88 | 84 | 88 |

TABLE 28
Example A Seed Germination on Kidney Beans

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 74 | 88 | 91 | 82 | 67 | 84 | 81 | 84 |
| 1.05 oz/100 cwt | 85 | 85 | 91 | 81 | 69 | 88 | 87 | 86 |
| 2.1 oz/100 cwt | 74 | 86 | 89 | 83 | 75 | 86 | 83 | 86 |
| 4.2 oz/100 cwt | 74 | 75 | 86 | 76 | 71 | 84 | 82 | 78 |
| 1:1 w/DI Water | 73 | 80 | 86 | 85 | 80 | 87 | 89 | 84 |

TABLE 29
Example A Seed Germination on Navy Beans

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 80 | 77 | 86 | 71 | 73 | 79 | 81 | 89 |
| 1.05 oz/100 cwt | 75 | 78 | 85 | 73 | 70 | 78 | 79 | 89 |
| 2.1 oz/100 cwt | 76 | 75 | 86 | 68 | 70 | 81 | 82 | 86 |
| 4.2 oz/100 cwt | 78 | 73 | 78 | 63 | 68 | 79 | 78 | 79 |
| 1:1 w/DI Water | 71 | 71 | 79 | 68 | 67 | 79 | 79 | 86 |

TABLE 30
Example A Seed Germination on Pinto Beans

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 78 | 68 | 62 | 70 | 71 | 86 | 94 | 62 |
| 1.05 oz/100 cwt | 72 | 62 | 57 | 65 | 70 | 79 | 57 | 60 |
| 2.1 oz/100 cwt | 81 | 63 | 69 | 70 | 67 | 83 | 59 | 61 |
| 4.2 oz/100 cwt | 74 | 48 | 57 | 51 | 68 | 76 | 58 | 64 |
| 1:1 w/DI Water | 82 | 55 | 64 | 60 | 68 | 78 | 57 | 59 |

TABLE 31
Example A Seed Germination on Lentils

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 96 | 96 | 96 | 96 | 91 | 98 | 97 | 95 |
| 1.05 oz/100 cwt | 96 | 97 | 96 | 98 | 95 | 97 | 98 | 96 |
| 2.1 oz/100 cwt | 96 | 96 | 96 | 93 | 96 | 97 | 97 | 97 |
| 4.2 oz/100 cwt | 85 | 93 | 95 | 94 | 90 | 97 | 97 | 95 |
| 1:1 w/DI Water | 96 | 95 | 96 | 96 | 95 | 97 | 98 | 95 |

TABLE 32
Example A Seed Germination on Chick Pea

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 43 | 37 | 34 | 47 | 92 | 82 | 91 | 87 |
| 1.05 oz/100 cwt | 34 | 26 | 27 | 39 | 92 | 84 | 88 | 91 |
| 2.1 oz/100 cwt | 22 | 19 | 15 | 26 | 91 | 88 | 92 | 87 |
| 4.2 oz/100 cwt | 6 | 1 | 2 | 2 | 82 | 72 | 92 | 77 |
| 1:1 w/DI Water | 28 | 10 | 18 | 8 | 87 | 87 | 89 | 89 |

TABLE 33
Example A Seed Germination on Canola

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 82 | 81 | 82 | 81 | 83 | 79 | 81 | 80 |
| 1.05 oz/100 cwt | 81 | 80 | 87 | 79 | 85 | 81 | 83 | 74 |
| 2.1 oz/100 cwt | 80 | 77 | 82 | 80 | 85 | 81 | 85 | 79 |
| 4.2 oz/100 cwt | 83 | 78 | 84 | 79 | 82 | 86 | 83 | 77 |
| 1:1 w/DI Water | 76 | 80 | 76 | 78 | 84 | 73 | 74 | 73 |

TABLE 34
Example A Seed Germination on Sunflower

| | Warm Germ | | | | Cold Germ | | | |
|---|---|---|---|---|---|---|---|---|
| | | 7 | 14 | 2 | | 7 | 14 | 2 |
| Treatment | Initial | Day | Day | mo | Initial | Day | Day | mo |
| Untreated Control | 95 | 90 | 93 | 89 | 78 | 87 | 89 | 89 |
| 1.05 oz/100 cwt | 94 | 89 | 89 | 90 | 76 | 88 | 88 | 90 |
| 2.1 oz/100 cwt | 96 | 89 | 91 | 89 | 77 | 87 | 88 | 89 |
| 4.2 oz/100 cwt | 94 | 89 | 92 | 88 | 76 | 89 | 88 | 88 |
| 1:1 w/DI Water | 95 | 93 | 93 | 87 | 76 | 83 | 88 | 87 |

Custom Blending is a popular commercial tool to deliver multiple pesticidal active ingredients to seeds by blending specific ratios of commercial products. It was discovered that Example 1 had surprisingly good compatibility when utilized in custom blends.

TABLE 35
MMEP
Custom Blend - 1

| Component | oz/cwt | w/w % | 500 g |
|---|---|---|---|
| Resonate 600 ST | 1.70 | 38.20 | 191.01 |
| Thiabendazole 4L ST | 0.16 | 3.60 | 17.98 |
| Example 1 | 1.05 | 23.60 | 117.98 |
| Rizolex | 0.30 | 6.74 | 33.71 |
| Red Colorant | 0.74 | 16.63 | 83.15 |
| TS Polymer 604 | 0.40 | 8.99 | 44.94 |
| ALB 100 ST | 0.10 | 2.25 | 11.24 |
| | 4.45 | 100.00 | 500.00 |

| | Day 0 | 30 D | 60 D |
|---|---|---|---|
| Viscosity | 1097 | 1550 | 1437 |
| Pass 100 | N/A | N/A | Pass |
| Mesh | | | |

TABLE 36
MMEP
Custom Blend - 2

| Component | oz/cwt | w/w % | 500 g |
|---|---|---|---|
| Resonate 600 ST | 1.80 | 34.29 | 171.43 |
| Thiabendazole 4L ST | 0.64 | 12.19 | 60.95 |
| Example 1 | 1.05 | 20.00 | 100.00 |
| Rizolex | 0.30 | 5.71 | 28.57 |
| Heads Up | 0.16 | 3.05 | 15.24 |
| Azoxystrobin 100 ST | 0.16 | 3.05 | 15.24 |
| Red Colorant | 0.75 | 14.29 | 71.43 |
| TS Polymer 604 | 0.29 | 5.52 | 27.62 |
| ALB 100 ST | 0.10 | 1.90 | 9.52 |
| | 5.25 | 100.00 | 500.00 |

| | Day 0 | 30 D | 60 D |
|---|---|---|---|
| Viscosity | 1080 | 1297 | 1213 |
| Pass 100 | N/A | N/A | Pass |
| Mesh | | | |

TABLE 37
MMEP Custom Blend -3

| Component | oz/cwt | w/w % | 500 g |
|---|---|---|---|
| Resonate 600 ST | 1.60 | 35.56 | 177.78 |
| Thiabendazole 4L ST | 0.20 | 4.44 | 22.22 |
| Example 1 | 1.05 | 23.33 | 116.67 |
| Thiophanate-methyl 4L | 0.28 | 6.22 | 31.11 |
| ST | | | |
| Azoxystrobin 100 ST | 0.30 | 6.67 | 33.33 |
| Red Colorant | 0.73 | 16.22 | 81.11 |
| TS Polymer 604 | 0.24 | 5.33 | 26.67 |
| ALB 100 ST | 0.10 | 2.22 | 11.11 |
| | 4.50 | 100.00 | 500.00 |

| | Day 0 | 30 D | 60 D |
|---|---|---|---|
| Viscosity | 953 | 1430 | 1377 |
| Pass 100 | N/A | N/A | Pass |
| Mesh | | | |

TABLE 38
MMEP
Custom Blend - 4

| Component | oz/cwt | w/w % | 500 g |
|---|---|---|---|
| Resonate 600 ST | 1.80 | 33.03 | 165.14 |
| Thiabendazole 4L ST | 0.64 | 11.74 | 58.72 |
| Example 1 | 1.05 | 19.27 | 96.33 |
| Heads Up | 0.16 | 2.94 | 14.68 |
| Azoxystrobin 100 ST | 0.16 | 2.94 | 14.68 |
| BioST VPH | 0.75 | 13.76 | 68.81 |
| Red Colorant | 0.56 | 10.28 | 51.38 |
| TS Polymer 604 | 0.23 | 4.22 | 21.10 |
| ALB 100 ST | 0.10 | 1.83 | 9.17 |
| | 5.45 | 100.00 | 500.00 |

| | Day 0 | 30 D | 60 D |
|---|---|---|---|
| Viscosity | 680 | 620 | 467 |
| Pass 100 | N/A | N/A | |
| Mesh | | | |

TABLE 39
MMEP
Custom Blend - 5

| Component | oz/cwt | w/w % | 500 g |
|---|---|---|---|
| Resonate 480 ST | 0.60 | 12.00 | 60.00 |
| BioST Insecticide | 1.00 | 20.00 | 100.00 |
| 100 | | | |
| Nipsit Inside | 0.25 | 5.00 | 25.00 |
| Difenoconazole 3L | 0.50 | 10.00 | 50.00 |
| ST | | | |
| Example 1 | 0.85 | 17.00 | 85.00 |
| Thiabendazole 4L ST | 0.17 | 3.40 | 17.00 |
| TebuStar 250 ST | 0.05 | 1.00 | 5.00 |
| Rizolex | 0.30 | 6.00 | 30.00 |
| Red Colorant | 1.00 | 20.00 | 100.00 |
| ALB 200 ST | 0.18 | 3.60 | 18.00 |
| | 0.10 | 2.00 | 10.00 |
| | 5.00 | 100.00 | 500.00 |

| | Day 0 | 30 D | 60 D |
|---|---|---|---|
| Re-Suspend | N/A | | |
| Viscosity | 403 | 1227 | 1077 |
| Pass 100 | N/A | N/A | Pass |
| Mesh | | | |

TABLE 40
MMEP
Custom Blend - 6

| Component | oz/cwt | w/w % | 500 g |
|---|---|---|---|
| Resonate 480 ST | 0.60 | 16.90 | 84.51 |
| Difenoconazole 3L | 0.75 | 21.13 | 105.63 |
| ST | | | |
| Example 1 | 0.85 | 23.94 | 119.72 |
| Thiabendazole 4L ST | 0.17 | 4.79 | 23.94 |
| Rizolex | 0.30 | 8.45 | 42.25 |
| Red Colorant | 0.75 | 21.13 | 105.63 |
| ALB 200 ST | 0.13 | 3.66 | 18.31 |
| | 3.55 | 100.00 | 500.00 |

| | Day 0 | 30 D | 60 D |
|---|---|---|---|
| Re-Suspend | N/A | | |
| Viscosity | 557 | 1740 | 1917 |
| Pass 100 | N/A | N/A | Pass |
| Mesh | | | |

TABLE 41
MMEP
Custom Blend - 7

| Component | oz/cwt | w/w % | 500 g |
|---|---|---|---|
| Resonate 480 ST | 0.60 | 17.65 | 88.24 |
| Difenoconazole 3L | 0.75 | 22.06 | 110.29 |
| ST | | | |
| Example 1 | 0.85 | 25.00 | 125.00 |
| Thiabendazole 4L ST | 0.17 | 5.00 | 25.00 |
| Rizolex | 0.30 | 8.82 | 44.12 |
| Green Colorant | 0.60 | 17.65 | 88.24 |
| ALB 200 ST | 0.13 | 3.82 | 19.12 |
| | 3.40 | 100.00 | 500.00 |

| | Day 0 | 30 D | 60 D |
|---|---|---|---|
| Re-Suspend | N/A | | |
| Viscosity | 630 | 637 | 903 |
| Pass 100 | N/A | N/A | Pass |
| Mesh | | | |

TABLE 42
MMEP
Custom Blend - 8

| Component | oz/cwt | w/w % | 500 g |
|---|---|---|---|
| Resonate 480 ST | 0.31 | 9.39 | 46.97 |
| Difenoconazole 3L | 0.75 | 22.73 | 113.64 |
| ST | | | |
| Example 1 | 0.65 | 19.70 | 98.48 |
| Thiabendazole 4L ST | 0.17 | 5.15 | 25.76 |
| Rizolex | 0.30 | 9.09 | 45.45 |
| Red Colorant | 1.00 | 30.30 | 151.52 |
| ALB 200 ST | 0.12 | 3.64 | 18.18 |
| | 3.30 | 100.00 | 500.00 |

| | Day 0 | 30 D | 60 D |
|---|---|---|---|
| Re-Suspend | N/A | | |
| Viscosity | 700 | 2210 | 2777 |
| Pass 100 | N/A | N/A | Pass |
| Mesh | | | |

TABLE 43
MMEP
Custom blend - 9

| Component | oz/cwt | w/w % | 500 g |
|---|---|---|---|
| Fludioxonil 4L ST | 0.06 | 2.11 | 10.56 |
| Example 1 | 0.55 | 19.37 | 96.83 |
| Rizolex | 0.30 | 10.56 | 52.82 |
| Resonate 480 ST | 0.38 | 13.38 | 66.90 |
| BioST VPH | 0.75 | 26.41 | 132.04 |
| Red Colorant | 0.75 | 26.41 | 132.04 |
| ALB 200 ST | 0.05 | 1.76 | 8.80 |
| | 2.84 | 100.00 | 500.00 |

| | Day 0 | 30 D | 60 D |
|---|---|---|---|
| Re-Suspend | | | |
| Viscosity | 1060 | 1823 | 1777 |
| Pass 100 | N/A | N/A | Pass |
| Mesh | | | |

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What I claim:

1. A seed treatment pesticide formulation comprising at least one pesticidally active ingredient solubilized in at least one solvent wherein said at least one solvent includes one or more alcohols, and at least one surfactant.

2. The treatment of claim 1, said treatment of aqueous nature;

3. The treatment of claim 1, said treatment of a non-aqueous nature;

4. The treatment of claim 1 wherein said at least one pesticidally active ingredient comprises 0.1-35% w/w of said seed treatment pesticide formulation.

5. The treatment of claim 4 said at least one pesticidally active ingredient comprising metalaxyl, said at least one solvent comprising at least one alcohol selected from the group consisting of: Acetone, Acetonitrile, 1,2-Butanediol, 1,3-Butanediol, 1,4-Butanediol, Diethanolamine, Diethylenetriamine, Dimethyl Solfoxide, Ethanol, Ethylamine, Ethylene Glycol, Furfuryl Alcohol, Glycerol, Methanol, Methyl Diethanolamine, 1-Propanol, 1,3-Propanediol, 1,5-Pentanediol, 2-Proponal, Propylene Glcyol, Tetrahydrofuran, and Triethylene Glycol tetrahydrofururyl alcohol.

6. The treatment of claim 4 said at least one surfactant including an ethoxylated non-ionic surfactant.

7. A seed treatment formulation comprising a micro-emulsion concentrate formulation having about 0.1%-35% w/w of at least one pesticide active ingredients, about 2%-98% alcohol, about 0.1%-98% w/w water, an antifoam at 0.01-1% w/w and a surfactant.

8. The treatment of claim 7 wherein said alcohol comprises at least one from the group consisting of Acetone, Acetonitrile, 1,2-Butanediol, 1,3-Butanediol, 1,4-Butanediol, Diethanolamine, Diethylenetriamine, Dimethyl Solfoxide, Ethanol, Ethylamine, Ethylene Glycol, Furfuryl Alcohol, Glycerol, Methanol, Methyl Diethanolamine, 1-Propanol, 1,3-Propanediol, 1,5-Pentanediol, 2-Proponal, Propylene Glcyol, Tetrahydrofuran, and Triethylene Glycol.

9. The treatment of claim 7 wherein application of said formulation to seeds results in an equal or smaller than a statistically significant drop in germination rate as compared to seeds not treated by the formulation.

10. The treatment of claim 7 wherein said pesticide active ingredient comprises at least one from the group; metalaxyl, fludioxonil, toclofos-methyl, Azoxystrobin, Tebuconazole, tetrahydrofurfurylalcohol and the formulation is applied directly to seeds;

11. The treatment of claim 7 wherein said surfactant comprises an ethoxylated non-ionic surfactant selected from a group comprising: 5-40 mol ethoxylated castor oil, Block Co-Polymers, Tristyrlphenol Ethoxylates, Ethoxylated Alkyl Phenols, Ethoxylated Fatty Acids, Ethoxylated Fatty Amines and other Ethoxylated Glyceridies.

12. A seed treatment composition applied directly to seed said composition comprising at least one pesticidally active ingredient solubilized in at least one solvent to form a micro-emulsion upon addition of specific surfactants.

13. The composition of claim 12 said composition exhibiting favorable stability and solubility for the active ingredient, enhanced long term storage stability, adequate compatibility with custom blend applications, and biological safety for seed.

14. A method of using the composition of claim 13 wherein the composition is directly applied to seeds.

15. A method of using the composition of claim 13 wherein the composition is diluted with an agricultural solvent and then applied to seeds without causing phytotoxicity.

16. The composition of claim 12 applied to seed without statistically increasing the number of seeds that do not germinate or are not viable over the rate expected when using traditional seed treatments.

17. The composition of claim 12 said solvent comprising a water miscible solvent.

18. The composition of claim 17 wherein said water miscible solvent is Tetrahydrofurfuryl Alcohol.

19. The composition of claim 17 wherein said composition comprises no visibly detectable crystals after storage at a temperature of about −6 C for six weeks.

20. The composition of claim 17 wherein said composition comprises no visibly detectable crystals after storage at a temperature of about 45 C for six weeks.

21. The composition of claim 17 wherein said composition comprises no visibly detectable crystals after freeze thaw cycles.
